(19) United States
(12) Patent Application Publication
(10) Pub. No.: US 2014/0373496 A1
(43) Pub. Date: Dec. 25, 2014

(54) HARVESTING MACHINE COMPRISING A SERVO-CONTROL MEANS FOR THE LIFTING HEIGHT OF A WORK TOOL

(71) Applicant: KUHN S.A., Saverne (FR)

(72) Inventors: Mathieu SCHOTT, Cosswiller (FR); Damien MARX, Saverne (FR)

(73) Assignee: KUNH S.A., Saverne (FR)

(21) Appl. No.: 14/306,590

(22) Filed: Jun. 17, 2014

(30) Foreign Application Priority Data
Jun. 25, 2013 (FR) 13 56029

(51) Int. Cl. A01D 34/00

(52) U.S. Cl. CPC A01D 34/008
USPC 56/10.2 E

(57) ABSTRACT

The present invention relates to a harvesting machine with an arm comprising a first part articulated to a chassis and a second part connected to the first part and carrying a work tool, with first and second devices used for adjusting a distance between the work tool and the chassis, between minimum and maximum values, and for displacing the work tool vertically between a work position and a raised position above the ground, and with servo-control means for positioning at least one of these first and second devices in accordance with a control setpoint which determines a target height of the work tool relative to the ground. According to the invention, the servo-control means makes it possible to raise the work tool to a height substantially equal to this target height, from two transverse positions located at a distance from the chassis between the minimum and maximum values.

### BACKGROUND OF THE INVENTION

1. Field of the Invention

The present invention relates to an agricultural machine for harvesting forage, displaceable in a direction of advance and comprising a chassis to which at least one arm carrying at least one work tool is articulated, this arm comprising at least a first part articulated directly or indirectly to the chassis and a second part connected in a mobile manner to the first part and carrying the work tool, the machine also comprising at least a first actuating device connected to the first part and a second actuating device connected to the second part, at least one of these first and second actuating devices being controlled to adjust a distance measured transversely to the direction of advance and from which the work tool extends laterally relative to the chassis, between a minimum value and a maximum value, at least the other of these first and second actuating devices being controlled to displace the work tool vertically between at least one work position and at least one raised position in which the work tool extends at a certain height above the ground, the machine comprising servo-control means for positioning at least one of these first and second actuating devices in accordance with a control setpoint which determines a target height of the work tool relative to the ground.

2. Discussion of the Background

A machine of this type is marketed by the applicant. This machine is a windrower for plants spread out on the ground, comprising two rotors each located on a side of the chassis of the machine. Each rotor is mounted on a rotation axle substantially vertical during work, the rotation axle being borne by a telescopic arm. This arm comprises a first part articulated to the chassis by means of a swivel pin horizontally orientated in the direction of advance. A first jack is articulated between the chassis and this first part of the arm in such a way as to displace the rotor vertically between a work position, a raised position used to pass over windrows already formed or obstacles, and a transport position in which the rotation axle of the rotor is substantially horizontal. The second part of the arm can slide inside the first part of the arm, this sliding being operated by a second jack articulated between the parts of the arm. Thanks to this sliding linkage, the distance separating the rotation axle of the rotor from the swivel pin of the first part of the arm is adjustable between a minimum value and a maximum value. In this way, the working width obtained with the rotors can be changed, in particular depending on the processing capacity of the baler or the chopper used to gather the windrow. On this known machine, each rotor is displaced towards the raised position by swivelling of the arm through a certain angle. This angle is determined by the travel path of the corresponding first jack which is controlled by servo-control positioning means. These servo-control means comprise a valve fastened to the chassis, a lever which controls the opening and closing of the valve, and an adjustment means which links the lever to the first part of the arm. This adjustment means is constituted by an oblong hole made in the first part of the arm, inside which the lever can be displaced and clamped in different positions. Each position of the lever inside the oblong hole forms a control setpoint which determines a target height of the rotor relative to the ground. Each of these positions in fact defines a swivelling angle through which the first part of the arm swivels when the rotor is raised from the ground, at which angle the lever controls the closure of the valve in such a way as to stop the displacement of the first jack and thus to immobilise the first part of the arm at the swivelling angle. A drawback with these servo-control means is that each control setpoint determines a target height of the rotor which varies, in particular increases, with the distance separating the rotation axle of the rotor from the swivel pin of the first part of the arm. The sliding linkage, substantially horizontal during work, in fact is inclined upwards and outwards relative to the chassis when the rotor is raised. Consequently, if the control setpoint determines a minimum target height, the rotor can be raised from the ground with a sufficient amplitude when the working width is adjusted to the maximum, but on another hand there is a high risk of this amplitude being insufficient when the working width is minimal. In such a case, there is a risk of the raised rotor undoing the windrows already formed or hitting an obstacle. In the opposite case of a control setpoint giving a maximum target height, there is a high risk of the vertical clearance of the rotor positioned at the maximum distance from the chassis greatly exceeding that required to pass over the windrows formed or obstacles generally encountered in the field. With this raised configuration of the rotors, the particularly high centre of gravity of the machine easily destabilizes the latter if the ground is irregular or the advance speed is too great. The servo-control means of the known machine do not therefore permit to obtain an optimum lifting of the rotors for the different adjusted working widths and for the various situations encountered during work and during maneuvers.

Document EP 2 253 186 A1 describes a machine according to the preamble of claim 1, the work tool whereof is constituted by a rotor for raking plants lying on the ground. This machine, however, comprises only one transverse work position of the work tool relative to the chassis. Consequently, this machine has a limited adaptation to various work situations, because its total working width and the width of the windrow formed from the raked plants are fixed.

### SUMMARY OF THE INVENTION

The aim of the present invention is to propose an agricultural machine for harvesting forage that does not present the aforementioned drawbacks.

For this purpose, an important feature of the invention consists in the fact that the servo-control means are configured for raising the work tool to a height above the ground substantially equal to the target height, from at least two transverse work positions of the work tool located at a distance from the chassis between the minimum and maximum values.

When the work tool is displaced from an initial work position towards a raised position by means of at least one of the first and second actuating devices, the servo-control means act in such a way that it is located at a height above the ground substantially equal to the target height, and this whether the work tool is initially located in a first transverse work position, for example that corresponding to the minimum working width, or in a second transverse work position, for example that associated with the maximum working width. Since the control setpoint is, for example, defined in order that the lifting height of the work tool is always sufficient to pass over the windrows formed or obstacles, in particular when the work tool is positioned at a distance from the chassis close to the minimum value, the servo-control means are thus able to prevent the work tool from being raised excessively above the ground, in particular when the work tool is positioned at a distance from the chassis close to the maximum value. Thus, in the raised position of the work tool, the machine according to the invention has sufficient stability whilst at the same time the ground clearance of the work tool is sufficient.

According to an advantageous feature of the invention, the servo-control means are configured to raise the work tool to a height above the ground substantially equal to the target height, from any transverse work position of the work tool located at a distance from the chassis between the minimum and maximum values. Thus, whether the work tool is located initially in a first transverse work position corresponding to the minimum working width, or in a second transverse work position associated with the maximum working width, or whatever the working width initially adjusted, the work tool is always raised to a height above the ground substantially equal to the target height. This latter is therefore advantageously determined or adjusted to guarantee, in all circumstances, both sufficient clearance of the work tool above the ground, and a centre of gravity located at a reasonable height for maintaining good stability.

According to another advantageous feature of the invention, the servo-control means comprise an adjustment means allowing to adjust the control setpoint. This adjustment means allows the user to intervene easily into the movements of the harvesting tools with a view to adapting his machine to the different situations encountered during work or during maneuvers.

### BRIEF DESCRIPTION OF THE DRAWINGS

Other features and advantages of the invention will emerge from the following description making reference to the appended drawings, which represent a non-limiting embodiment of the machine according to the invention.

In these drawings:

FIG. 1 represents a perspective view of an embodiment of a machine according to the invention;

FIG. 2 represents a partial front view of a first variant of embodiment of the machine from FIG. 1;

FIG. 3 represents a partial front view of a second variant of embodiment of the machine from FIG. 1.

### DESCRIPTION OF THE PREFERRED EMBODIMENTS

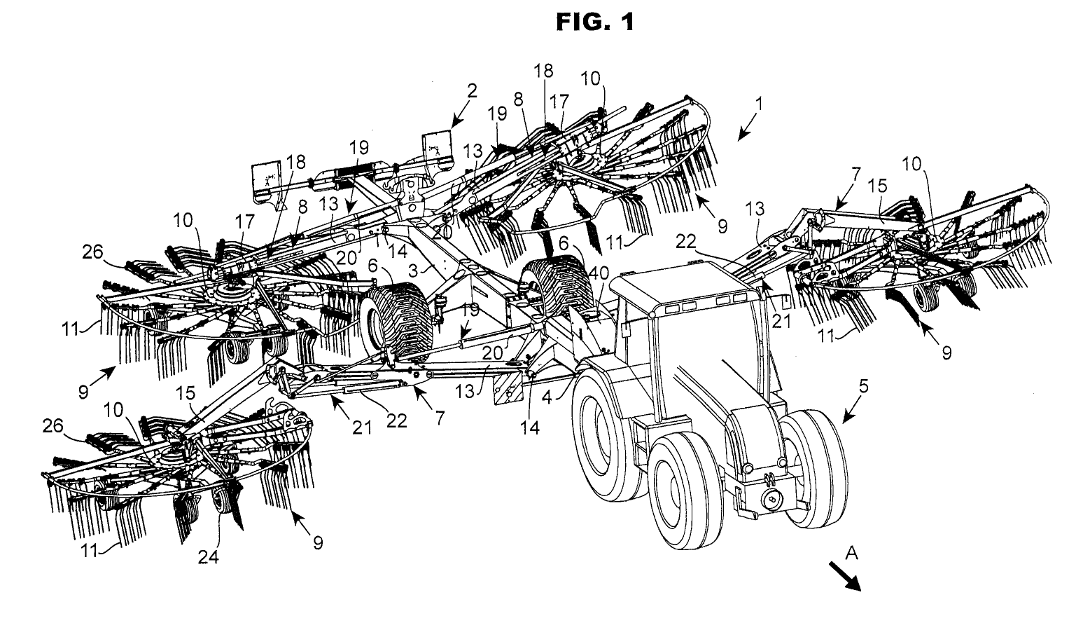

As represented in FIG. 1, the machine 1 according to the invention comprises a chassis 2 comprising a central beam 3 which has at its front end a hitching device 4 for hitching it to a tractor 5 making it possible to displace the machine 1 in a direction of advance A. In the following description, the terms “front” and “rear” are defined with respect to the direction of advance A, whilst the terms “high”, “above”, “below”, “upward” and “upper” relate to the ground.

In the embodiment represented in FIG. 1, the chassis 2 rests directly on the ground by wheels 6. These wheels 6 are mounted on an axle, itself connected to the central beam 3. Articulated to the chassis 2 is at least one arm 7, 8 carrying at least one work tool 9. In this embodiment, the work tool 9 comprises a rotor 10 with tools 11, such as forks, intended to displace products such as mown grass or straw lying on the ground. The rotor 10 can rotate around a rotation axle 12 which is substantially vertical during work. In this embodiment, the machine 1 comprises a first pair of work tools 9 located in front of the wheels 6 and distributed on each respective side of the central beam 3 as well as a second pair of work tools 9 located behind the wheels 6 and distributed on each respective side of the central beam 3.

Each work tool 9 is carried by a respective arm 7, 8. On each side of the central beam 3 of the chassis 2, the arms 7 and 8 have different lengths. In this way, the rotors 10 positioned in front are farther away from the central beam 3 than the rear rotors 10. The plants windrowed by the rotor 10 located farther in front on one side of the central beam 3 can then be taken up by the rotor 10 arranged farther behind on the same side of the central beam 3 for the formation of a single windrow of greater volume. The arm 7, 8 comprises a first part 13 connected directly to the chassis 2 by means of a first articulation comprising a first swivel pin 14. This first swivel pin 14 is orientated in such a way that the first part 13 of the arm 7, 8 can be displaced in a plane transverse to the direction of advance A. This first swivel pin 14 has for example an orientation close to the horizontal and/or close to the direction of advance A. An arm 7 located in front of the wheels 6 comprises a second part 15 connected in a mobile manner to the first part 13 by means of a second articulation comprising a second swivel pin 16. This second swivel pin 16 has for example an orientation close to the horizontal and/or close to the direction of advance A. At its end distant from the second articulation, the second part 15 of the arm 7 carries a work tool 9. An arm 8 located behind the wheels 6 comprises a second part 17 connected in a mobile manner to the first part 13 by means of a sliding linkage 18. This second part 17 comprises for example a carriage carrying the work tool 9 and capable of rolling inside a groove made in the first part 13 of the arm 8 and orientated in a longitudinal direction of this first part 13 of the arm 8. The sliding linkage 18 can also be obtained by a second part 17 in the form of a tube carrying the work tool 9 and sliding inside a slightly larger tube which is comprised by the first part 13.

A first actuating device 19 is connected to the first part 13 of the arm 7, 8. This first actuating device 19 is also connected to the chassis 2. This first actuating device 19 comprises a jack 20, in particular a hydraulic jack, articulated to the chassis 2 and to the first part 13. The first actuating device 19 causes the first part 13 of the arm 7, 8 to swivel relative to the chassis 2 in a plane transverse to the direction of advance A. This plane is also substantially vertical. The first actuating device 19 is controlled so as to displace the work tool 9 vertically between at least one work position and at least one raised position in which the work tool 9 extends at a certain height above the ground, in order for example to pass over windrows or obstacles. In FIG. 1, each work tool 9 located, viewed in the direction of advance A, to the right of the central beam 3 of the chassis 2 is in the work position, whereas each work tool 9 located on the left is in a raised position. In these positions, the second articulation of an arm 7 located in front of the wheels 6 extends, in a projection on a substantially horizontal plane, at a certain distance from the first articulation. The sliding linkage 18 of an arm 8 located behind the wheels 6 is orientated transverse to the direction of advance A. When the corresponding work tool 9 rests on the ground, this sliding linkage 18 has an orientation close to the horizontal. In the raised position of the work tool 9, the sliding linkage 18 is orientated obliquely upwards and outwards relative to the central beam 3 of the chassis 2. The first actuating device 19 can also be controlled so as to displace the work tool 9 towards a transport position. In this position, the second articulation of an arm 7 located in front of the wheels 6 is located substantially above the first articulation. As for an arm 8 located behind the wheels 6, its sliding linkage 18 then has an orientation close to the vertical.

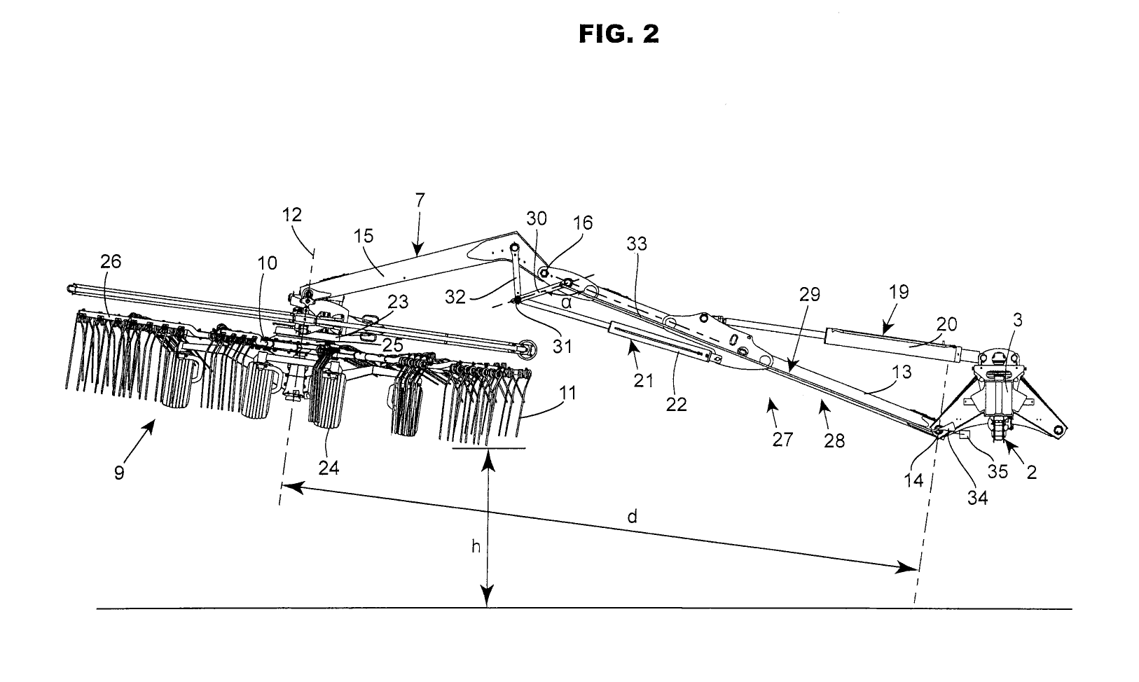

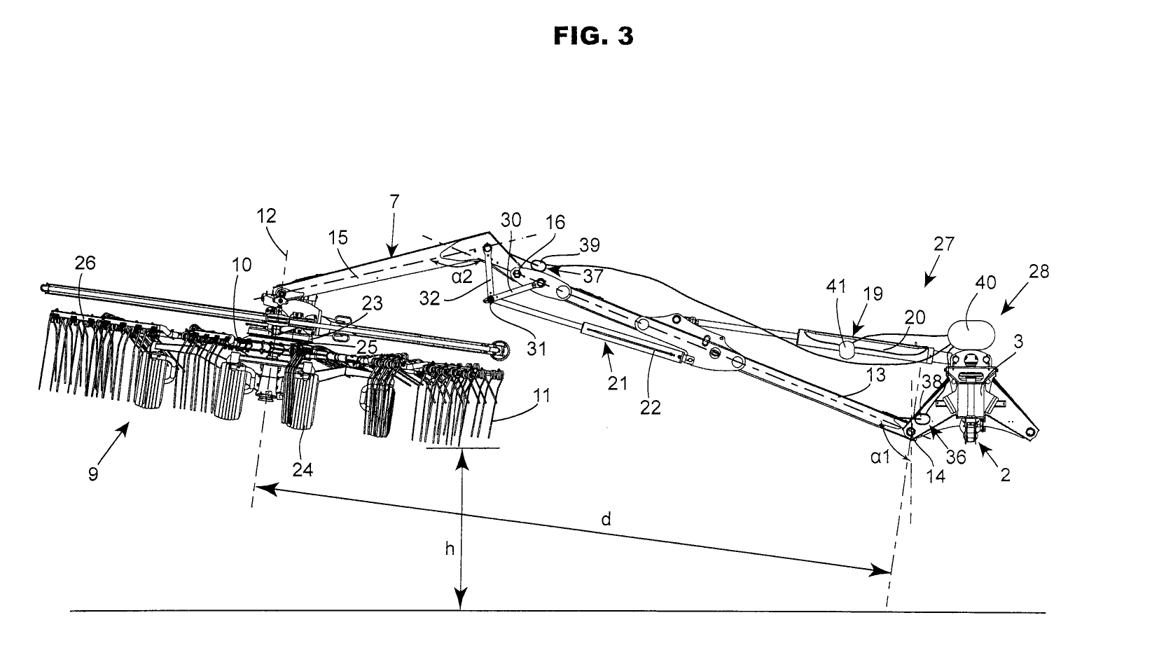

A second actuating device 21 is connected to the second part 17 of the arm 7, 8. This second actuating device 21 is connected to the first part 13. This second actuating device 21 comprises a jack 22, in particular a hydraulic jack, articulated to the first part 13 and to the second part 15, 17. The control of the second actuating device 21 makes it possible to adjust the distance d, measured transverse to the direction of advance A, by which the work tool 9 extends laterally relative to the chassis 2, with a view to adjusting the working width of the machine 1 and/or the width of the windrow formed. This distance d separates the central beam 3 of the chassis 2 from a geometrical reference of the work tool 9. For the chassis 2, the distance d is calculated for example from the first swivel pin 14 of the arm 7, 8. The geometrical reference is for example an inner end of the work tool 9 close to the central beam 3. In the embodiment of the figures, the geometrical reference is the rotation axle 12 of the rotor 10, and the distance d is measured between this rotation axle 12 and the first swivel pin 14 of the arm 7, 8 on the chassis 2. For an arm 7 located in front of the wheels 6, the second actuating device 21 causes the second part 15 of the arm 7 to swivel relative to the first part 13 of the arm 7. This swivelling takes place in a plane transverse to the direction of advance A. This plane is also substantially vertical. The work tool 9 thus follows a circular trajectory around the second swivel pin 16. It therefore appears that, if the first actuating device 19 remains fixed at the same time, the height h of the work tool 9 relative to the ground varies. For a work tool 9, this height h separates the ground from the tools 11, in particular the lower ends of these tools 11, these lower ends being represented, in the embodiment of the figures, by the tips of the forks. In particular, this height h separates the ground from the lower end of the tool 11 located lowest when the work tool 9 is raised. In fact, as is shown in FIGS. 2 and 3, the work tool 9, being located in the raised position, may not extend parallel to the ground. At the bottom of these figures, the ground is represented by a horizontal line from which the height h is calculated. For an arm 8 located behind the wheels 6, a movement of the second actuating device 21 leads to a translation of the second part 17 of the arm 8 relative to the first part 13 of the arm 8 to which it is connected by means of the sliding linkage 18. The distance d separating the work tool 9 from the chassis 2 can be adjusted between a minimum value and a maximum value. In the embodiment of the figures, these two values are different between the work tools 9 located in front of the wheels 6 and those located behind.

The rotor 10 of a work tool 9 comprises a casing 23. The latter is connected to the corresponding arm 7, 8. The casing 23 supports the rotation axle 12. This rotation axle 12 comprises at its lower end a support with rollers 24 located beneath the rotor 10. These rollers roll on the ground during work and cause the rotors 10 to follow the unevenness of the ground. The support and the rollers 24 can advantageously slide along the rotation axle 12 in such a way as to adjust the distance of the tools 11 relative to the ground, for example by means of a jack. Arranged on the part of the rotation axle 12 that extends below the casing 23 is a housing 25. The latter is mounted on the rotation axle 12 by means of bearings in order to be able to be driven in rotation. To drive the rotor 10, the upper side of the housing 25 is provided for example with a toothed wheel which is located in the casing 23. This wheel meshes with a pinion, which can be connected to a power take-off of the tractor 5 by means of intermediate transmission shafts known to the person skilled in the art. The rotational drive for the rotor 10 can also be brought about with a hydraulic or electric motor. The rotor 10 comprises a multitude of oscillating arms 26 carrying the tools 11. These oscillating arms 26 are supported by the housing 25. These oscillating arms 26 extend in the form of radii with respect to the rotation axle 12, in a plane substantially perpendicular to the latter. The oscillating arms 26 comprise an inner part connected to the housing 25 and an outer part carrying the tools 11. The inner parts of the oscillating arms 26 are connected to the housing 25 via one or more bearings in such a way that they can rotate on themselves. Mounted on the part of the rotation axle 12 that is located in the housing 25 is a fixed cam intended to control the oscillating arms 26 during work. For this purpose, each of the oscillating arms 26 comprises, at its end extending inside the housing 25, a lever with a roller which is guided in a groove of the cam. During work, the tools 11 gather the products in particular on the front part of their trajectory and deposit them in the form of a windrow in the lateral part of their trajectory.

An agricultural machine 1 for harvesting forage according to the invention can be a haymaking machine, for example a windrower, in particular a windrower with four rotors such as that which has just been described. An agricultural machine 1 for harvesting forage according to the invention can of course also be a windrower with two rotors each located on a respective side of a central beam of the chassis. The central beam could also support only a single arm and only a single rotor. Moreover, the machine 1 can be, like that of the figures, of the trailed or semi-mounted type with a main train of wheels, by means of which the chassis of the machine 1 rests directly on the ground. The machine 1 can also be of the type mounted by means of the three-point hitching device of the tractor 5. In this case, the chassis of the machine 1 rests indirectly on the ground during work, by means of rollers located beneath the work tools 9. An agricultural machine 1 for harvesting forage according to the invention can also be a self-propelled machine, with a chassis put into motion by means of one or more driving and/or steering train(s) of wheels. An agricultural machine 1 for harvesting forage according to the invention can also be of the type known under the name “Merger”. The work tool of such a machine comprises a pick-up. The latter comprises a rotor capable of rotating around an axis orientated during work transverse to the direction of advance A and substantially horizontally. This rotor can be provided with teeth which describe a curved envelope when the rotor is actuated. The rotor can also serve as a winding support for a driven belt which carries teeth, forks or hooks. The pick-up precedes a conveyor which can be of the belt, roller or screw type. The conveyor receives the plants thrown backwards by the pick-up and displaces them transverse to the pick-up. The plants are then laid down again on the ground in the form of a windrow with a view to their being subsequently picked up.

According to other not represented embodiments of the machine 1, the first part 13 of the arm 7, 8 can be connected indirectly to the chassis 2, for example by means of an articulated rod assembly. Such an assembly is for example an articulated quadrilateral. The arm 7, 8 can also comprise more than two mobile parts. According to other not represented embodiments of the machine 1, the parts 13, 15, 17 of the arm 7, 8 and/or the actuating devices 19, 21 can be arranged in such a way that the adjustment of the distance d between the work tool 9 and the chassis 2 is obtained by actuating the first actuating device (19), or by actuating, sequentially or simultaneously, the two actuating devices 19 and 21. Similarly, the parts 13, 15, 17 of the arm 7, 8 and/or the actuating devices 19 and 21 can be arranged in such a way that the vertical displacement of the work tool 9 is obtained, at least between the work position and the raised position, by actuating the second actuating device 21, or even by actuating, sequentially or simultaneously, the two actuating devices 19 and 21.

The machine 1 according to the invention comprises servo-control means 27 for positioning at least one of the first and second actuating devices 19 and 21 in accordance with a control setpoint which determines a target height of the work tool 9 relative to the ground. These servo-control means 27 are configured to raise the work tool 9 to a height h above the ground substantially equal to this target height, from at least two transverse work positions of the work tool located at a distance d from the chassis 2, between the minimum and maximum values.

According to an advantageous feature of the invention, the servo-control means 27 are configured to raise the work tool to a height h above the ground substantially equal to this target height, from any transverse work position of the work tool 9 located at a distance d from the chassis 2 between the minimum and maximum values.

The servo-control means 27 comprise a conversion means 28 which delivers, on the basis of at least one physical input variable representative of a transverse work position of the work tool 9 located at a distance d from the chassis 2, between the minimum and maximum values, at least one control variable used for controlling at least one of the first and second actuating devices 19 and 21.

The machine 1 according to the embodiment of FIG. 1 comprises a first variant of embodiment of the servo-control means 27 of an arm 7 located in front of the wheels 6. In this first variant of embodiment illustrated in FIG. 2, the conversion means 28 comprises a rod and/or cable transmission means 29 articulated to the second part 15 of the arm 7 on one hand, and to the first part 13 of the arm 7 on another hand. A first lever 30, articulated to the first part 13 of the arm 7, shares a common swivel pin 31 with a second lever 32, itself articulated to the second part 15 of the arm 7. These two levers 30 and 32 are arranged in the vicinity of the second swivel pin 16. The common swivel pin 31 is connected to a second jack 22 constituting the second actuating device 21. This second jack 22 is articulated to the first part 13 of the arm 7. The first lever 30 carries a rod 33 which extends in the direction of the first swivel pin 14, along the first part 13 of the arm 7. The rod 33 of the transmission means 29 acts on a mechanical actuator 34 to which it is connected. This mechanical actuator 34 is constituted by a rocker. This rocker is mounted in a swivelling manner on a pin coincident with the first swivel pin 14. The side of the rocker located, relative to this pin, on the side opposite to that where the rocker is connected to the rod 33, acts on a cam carried by the swivel pin of a control element 35 constituted by a hydraulic valve linked to the chassis 2. The valve is located on the hydraulic supply of a first jack 20 constituting the first actuating device 19, which first jack 20 is articulated between the chassis 2 and the first part 13 of the arm 7. The displacement of the rocker causes a displacement of the cam. Depending on whether the first jack 20 is supplied for shortening or lengthening, i.e. depending on whether the first part 13 of the arm 7 is swiveled upwards or downwards, the displacement of the cam controls the opening or the closing of the valve, in such a way as to allow or to interrupt the hydraulic supply of the first jack 20. In this first variant of embodiment, the first jack 20 is provided for the vertical displacement of the work tool 9, whilst the second jack 22 is provided for adjusting the working width. For this purpose, the second jack 22 is controlled in such a way as to move the second part 15 of the arm 7 farther away from or closer to the first part 13 of the arm 7 and thus to the chassis 2. Thus, the work tool 9 is located at a distance d from the chassis 2 between the minimum and maximum values. This displacement of the second part 15 of the arm 7 changes an angle α which the first lever 30 forms with a length of the first part 13 of the arm 7. This angle α thus forms a physical input variable representative of the transverse work position of the work tool 9 located at a distance d from the chassis 2 between the minimum and maximum values. In this first variant of embodiment, the physical input variable is more particularly representative of the position of the second part 15 of the arm 7 relative to the first part 13 of the arm 7. Via the rod 33, the conversion means 28 delivers, on the basis of this physical input variable, a control variable to the control element 35 connected to the first jack 20 of the first actuating device 19. In this case, it is the position of the rocker constituting the mechanical actuator 34 that is used as the control variable. This position of the rocker can be marked out by an angle or by a distance, the value whereof represents the value taken by the control variable. When the first part 13 of the arm 7 is swiveled upwards by means of the first jack 20, the rocker is displaced with this first part 13 of the arm 7 and at a given moment reaches a position in which it closes the valve. This very precise position of the rocker is thus associated with a target value of the control variable, and the control element allows a power flow—here, a hydraulic flow—towards the first jack 20 as long as the value of the control variable—value of the angle or the distance defining the position of the rocker at instant t—has not reached this target value—the value of the angle or the distance defining the position of the rocker closing the valve. The interaction of the transmission means 29 with the first part 13 of the arm 7, with the second part 15 of the arm 7 and, via the mechanical actuator 34, with the control element 35, involves the existence of a relationship that links the target value to the value taken by the physical input variable, to the control setpoint, to dimensional parameters of the arm 7 and/or of the conversion means 28 and to the location parameters of the first part 13 of the arm 7 on the chassis 2. When the work tool 9 rests on the ground in a given transverse work position, the control setpoint that determines the target lifting height of the work tool 9 fixes a certain angular orientation of the rocker, around its axis, relative to the first part 13 of the arm 7, or relative to the valve. The servo-control means 27 can advantageously comprise an adjustment means making it possible to adjust this control setpoint, via a permanent offset of the mechanical actuator 34 in position relative to the arm 7 and/or relative to the control element 35. Thus, for a given transverse work position of the work tool 9 on the ground, the adjustment means changes the angular orientation of the rocker around its axis. The effect of this, for this given transverse work position, is to change the swivelling angle that the first part 13 of the arm 7 forms with the horizontal at which the valve passes from an open configuration to a closed configuration, and vice versa. The adjustment means can be a hydraulic jack or a screw-nut system forming part of the transmission means 29. The adjustment means can also be an adjustable stop on the rocker. Finally, the adjustment means can also be constituted by a means for adjusting the position of the valve on the chassis 2. The dimensional parameters of the arm 7 are for example the lengths of the first and second parts 13 and 15 of the arm 7. The dimensional parameters of the conversion means 28 are for example the lengths of the first and second levers 30 and 32, the length of the rod 33, the lever arm between the first lever 30 and the rod 33 and that between the rod 33 and the rocker. A location parameter of the first part 13 of the arm 7 on the chassis 2 is the height of the first swivel pin 14 relative to the ground. Another location parameter is for example the distance separating the first swivel pin 14 from the longitudinal geometrical axis of the central beam 3 of the chassis 2. An increase in the working width adjusted by means of the second jack 22 leads to an increase in the angle α. The rod 33 thus displaces the rocker around its axis in a direction such that the side of the rocker acting on the cam of the valve is lowered. When afterwards the work tool 9 is displaced from its work position towards a raised position, the rocker then closes the valve relatively quickly, and the corresponding swivelling angle of the first part 13 of the arm 7 will be small. If the working width is adjusted to a smaller value, the rocker closes the valve more slowly during the displacement of the work tool 9 from its work position towards a raised position. The corresponding swivelling angle of the first part 13 of the arm 7 will then be greater. The dimensional parameters of the conversion means 28, as appropriate those of the arm 7, are then selected in such a way that, for the control setpoint or for each control setpoint, the work tool 9 is raised to a height h above the ground substantially equal to the target height determined by the control setpoint, and this being from at least two transverse work positions of the work tool 9, in particular from each transverse work position of the work tool 9.

The machine 1 according to the embodiment of FIG. 1 comprises a second variant of embodiment of the servo-control means 27 of an arm 7 located in front of the wheels 6. A first lever 30, articulated to the first part 13 of the arm 7, shares a common articulation 31 with a second lever 32, itself articulated to the second part 15 of the arm 7. These two levers 30 and 32 are arranged in the vicinity of the second swivel pin 16. The common articulation pin 31 is connected to a second jack 22 constituting the second actuating device 21. This second jack 22 is articulated to the first part 13 of the arm 7. In this second variant of embodiment illustrated in FIG. 3, the servo-control means 27 comprise a conversion means using two physical input variables, at least one of which is representative of a transverse work position of the work tool 9 located at a distance d from the chassis 2 between the minimum and maximum values. In this second variant of embodiment, the first jack 20 is used for the vertical displacement of the work tool 9, whilst the second jack 22 is provided for adjusting the distance d between the work tool 9 and the chassis 2. The conversion means 28 comprises a first measuring means 36 supplying a first signal image of a first physical input variable representative of a position of the first part 13 of the arm 7 relative to the chassis 2. Moreover, the conversion means 28 comprises a second measuring means 37 supplying a second signal image of a second physical input variable representative of a position of the second part 15 of the arm 7 relative to the first part 13 of the arm 7. The first measuring means 36 comprises a first angle sensor 38 arranged in the vicinity of the first swivel pin 14. This first angle sensor 38 is arranged between the first part 13 of the arm 7 and the chassis 2. The first physical input variable is therefore a first angle α1 that the first part 13 of the arm 7 forms with respect to the chassis 2, for example, as illustrated in FIG. 3, with respect to a vertical line passing through the first swivel pin 14. This first angle α1 is in particular measured in the plane transverse to the direction of advance, in which the first part 13 of the arm 7 can swivel relative to the chassis 2. The first signal is an electrical signal delivered by this first angle sensor 38. The second measuring means 37 comprises a second angle sensor 39 arranged in the vicinity of the second swivel pin 16. This second angle sensor 39 is arranged between the first and second parts 13 and 15 of the arm 7. The second physical input variable is therefore a second angle α2 that the second part 15 of the arm 7 forms with respect to the first part 13 of the arm 7. The second signal is an electrical signal delivered by this second angle sensor 39. In this second variant of embodiment, the conversion means 28 comprises a computer 40 carried by the chassis 2. The latter is connected to the first and second measuring means 36 and 37, from which it receives the first and second signals in real time. As illustrated in FIG. 3, the connection of the computer 40 to the first and second measuring means 36 and 37 takes place via wiring harnesses. Moreover, the computer 40 contains a memory allowing it to memorize the control setpoint that determines the target lifting height of the work tool 9. The conversion means 28 delivers, on the basis of the first and second physical input variables, a control variable used to control an actuating device 19. For this purpose, the control variable is delivered in real time by the computer 40 on the basis of the first and second signal images of these first and second physical input variables. The control variable is delivered in real time by the computer 40 to a control element 41 with a view to controlling the first jack 20 of the first actuating device 19. This control variable is an electrical signal delivered, as illustrated in FIG. 3, via a wiring harness connecting the computer 40 to the control element 41. The control element 41 comprises a solenoid valve. This solenoid valve is controlled for opening and closing and is connected to the first jack 20. The computer 40 determined a target value for the control variable. The solenoid valve alternates from an open configuration to a closed configuration, and vice versa, when the value of this control variable is the target value. The control element 41 allows a power flow—here, a hydraulic flow—towards the first jack 20 as long as the value taken by the control variable has not reached the target value. This target value is linked by a relationship with the values taken by the first and second physical input variables, with the control setpoint, with dimensional parameters of the arm 7 and with location parameters of the first part 13 of the arm 7 on the chassis 2. This relationship comprises the respective transfer functions of the first and second measuring means 36 and 37 as well as a law stored by the computer 40. Each transfer function links the first, respectively the second physical input variable—measured angle, i.e. first angle α1, respectively second angle α2—to the first, respectively second electrical signal. The law brings in the values taken in real time by these first and second electrical signals, the control setpoint, as well as the dimensional parameters of the arm 7 and location parameters of the first part 13 of the arm 7 on the chassis 2. According to the value taken by the second angle α2 between the first and second parts 13 and 15 of the arm 7, converted by the second angle sensor 39 into the second electrical signal transmitted to the computer 40, the latter determines, on the basis of the stored relationship and the control setpoint having a certain value in this relationship, the first angle α1 from which the first part 13 of the arm 7 must be swiveled upwards when the work tool 9 is displaced from its work position towards a raised position coinciding with the target height associated with the control setpoint. For this purpose, the computer 40 determines, on the basis of the stored relationship and the control setpoint, a first target value for the first signal delivered by the first angle sensor 38. This first target value is the value that the first signal must take when the first swivelling angle α1 of the first part 13 of the arm 7 reaches the value corresponding to the work tool 9 located at a height h above the ground substantially equal to the target height. The computer 40 also comprises a first comparator which delivers a first comparison signal depending on the divergence between the first target value and the value taken by the first signal. The computer 40 determines the value of the control variable depending on the value taken by this first comparison signal. When the value taken by the first signal reaches the first target value, the computer 40 assigns the target value to the value of the control variable. In other words, the value of the control variable is such that the solenoid valve allows the passage of a hydraulic power flow towards the first jack 20 as long as the first signal is not equal to the first target value corresponding to the desired lifting height h of the work tool 9 for the pre-adjusted working width. When the distance d from the work tool 9 to the chassis 2 is changed by operation of the second jack 22, the second angle sensor 39 informs the computer 40 in real time of the actual second angle α2 between the first and second parts 13 and 15 of the arm 7. In doing so, the computer 40 recalculates in real time, on the basis of the stored law and the control setpoint, the new first target value with a view to adapting the first swivelling angle α1 of the first part 13 of the arm 7 to the newly adjusted working width. In this second variant of embodiment, the servo-control means 27 advantageously comprise an adjustment means making it possible to adjust the control setpoint. This adjustment means comprises for example a control terminal, from which the user can adjust the control setpoint.

Although the first and second variants of embodiment have been described above in connection with an arm 7 located in front of the wheels 6, comprising a second part 15 articulated to a first part 13, these two variants of embodiment can perfectly well be adapted to an arm 8 located behind the wheels 6. In the following description, a third variant of embodiment is defined as being an adaptation of the first variant of embodiment for this arm 8. Similarly, a fourth variant of embodiment is defined as being an adaptation of the second variant of embodiment for this arm 8 located behind the wheels 6.

The third variant of embodiment differs from the first essentially in that the rod and/or cable transmission means 29 is connected to the sliding carriage which is comprised by the second part 17. The second jack 22 is articulated between the first part 13 of the arm 8 and the sliding carriage. The transmission means 29 acts on a mechanical actuator 34 to which it is connected. The arrangement and the operation of this mechanical actuator 34 are identical to those provided in the first variant of embodiment. In this third variant of embodiment, the first jack 20 is provided for the vertical displacement of the work tool 9, whilst the second jack 22 is provided for adjusting the working width. For this purpose, the second jack 22 is controlled in such a way as to move the sliding carriage farther away from or closer to the first swivel pin 14 of the arm 8 on the chassis 2. Thus, the work tool 9 is located at a distance d from the chassis 2 between the minimum and maximum values. This displacement of the second part 17 of the arm 8 changes a second distance measured between two respective references of the first and second parts 13 and 17 of the arm 8. This second distance thus forms a physical input variable representative of the transverse work position of the work tool 9 located at a distance d from the chassis 2 between the minimum and maximum values. Via the transmission means 29, the conversion means 28 delivers, on the basis of this physical input variable, a control variable to a control element 35 represented by a hydraulic valve connected to the first jack 20. The interaction of the mechanical actuator 34 with the valve is, in principle, identical to that described for the first variant of embodiment. An increase in the adjusted working width, by means of the second jack 22, leads to an increase in the second distance used as a physical input variable. Depending on the value of this second distance, the mechanical actuator 34 closes the valve more or less quickly when the work tool 9 is displaced from its work position towards a raised position. In this way, the work tool 9 is raised to a height h equal to the target height fixed by the control setpoint, from at least two transverse work positions of the work tool 9, in particular from any transverse work position.

The fourth variant of embodiment differs from the second essentially in that the second measuring means 37 comprises a second distance sensor arranged between the sliding carriage of the second part 17 and the first part 13 of the arm 8. The second physical input variable is therefore a second distance between these parts 13 and 17. The transfer function of the second measuring means 37 thus links this second measured distance to the second electrical signal. According to the value of this second distance, converted by the second sensor into the second electrical signal transmitted to the computer 40, the latter determines, on the basis of the stored relationship and the control setpoint having a certain value in this relationship, the angle from which the first part 13 of the arm 8 must be swiveled upwards when the work tool 9 is displaced from its work position towards a raised position coinciding with the target height associated with the control setpoint. When the distance d of the work tool 9 from the chassis 2 is changed by actuation of the second jack 22, the second sensor informs the computer 40 in real time of the actual second distance between the first and second parts 13 and 17 of the arm 8. In doing so, the computer 40 recalculates in real time, on the basis of the stored law and the control setpoint, a new first target value for the first signal, with a view to adapting the swivelling angle of the first part 13 of the arm 8 to the newly adjusted working width.

Other variants of embodiment of the servo-control means 27 can provide a single physical input variable representative of a position of the first part 13 of the arm 7, 8 relative to the chassis 2. The first, second and third variants of embodiment could be modified such that the second physical input variable is representative of a position of the second part 15, 17 of the arm 7, 8 relative to the chassis 2.

Generally, a physical input variable of the conversion means 28 can be a linear or angular distance between the parts 13, 15, 17 of the arm 7, 8 or between a part 13, 15, 17 of the arm 7, 8 and the chassis 2, or a measured inclination of a part 13, 15, 17 of the arm 7, 8 relative to the ground. An associated measuring means can be an angle sensor, a distance sensor or an inclinometer. In the second variant of embodiment, the second measuring means 37 can comprise, instead of the second angle sensor 39, a second distance sensor. In this case, the second physical input variable is a second distance measured between two respective references of the first part 13 of the arm 7 and the second part 15 of the arm 7.

An embodiment of the machine can make provision such that the control variable is delivered to a control element 35, 41 controlled for opening and closing and connected to the second actuating device 21, and such that the control element 35, 41 allows a power flow towards the second actuating device 21 as long as the value of the control variable has not reached a target value. The conversion means 20 according to the first variant of embodiment would thus be modified such that the transmission means 29 acts on a mechanical actuator 34, whereof a position would be used as a control variable of the valve constituting the control element 35 and connected to the second actuating device 21. The conversion means 28 according to the second variant of embodiment would be modified such that the computer 40 memorizes the control setpoint, receives the first and second signals in real time and delivers the control variable in real time in order to control the second actuating device 21.

Other more or less developed embodiments of the machine 1 can make provision such that the conversion means 28 delivers, on the basis of one or several physical input variables representative of a transverse work position of the work tool 9, located at a distance d from the chassis 2 between the minimum and maximum values, several control variables for the control, sequentially or simultaneously, of the first and second actuating devices 19 and 21. In this case, each control variable is delivered to a respective control element 35, 41, controlled for opening and closing, and connected to the first, respectively the second actuating device 19, 21. Each respective control element 35, 41 thus allows a power flow towards the first, respectively the second actuating device 19, 21 as long as the value of the corresponding control variable has not reached a corresponding target value. In this case, a relationship links the target values of the control variables to the values taken by the physical input variables, to the control setpoint, to dimensional parameters of the arm 7, 8 and/or of the conversion means 28 and to location parameters of the first part 13 of the arm 7, 8 on the chassis 2. A conversion means 28, similar to that of the second or the fourth variant of embodiment, is therefore such that the computer 40 memorizes the control setpoint, receives the first and second signals in real time and delivers the control variables in real time in order to control the first and second actuating devices 19 and 21. This computer 40 determines, on the basis of the law that it stores and the control setpoint that it memorizes, a first target value for the first signal and a second target value for the second signal. For this purpose, this computer 40 comprises, in addition to a first comparator according to that which the second variant of embodiment comprises, a second comparator. The latter delivers a second comparison signal depending on the divergence between the second target value and the value taken by the second signal. The computer 40 then determines the value of each control variable depending on the value taken by the first comparison signal and the value taken by the second comparison signal.

The conversion means 28 according to the first or the third variant of embodiment can be modified such that its rod and/or cable transmission means 29 is articulated to the second part 15, 17 of the arm 7, 8 and to the chassis 2.

The conversion means 28 according to the second variant of embodiment can be modified such that the second measuring means 37 supplies a second signal image of a second physical input variable, representative of a position of the second part 15 of the arm 7 with respect to the chassis 2. The second physical input variable can thus be a second angle that the second part 15 of the arm 7 forms with respect to the chassis 2. The second measuring means 37 can also comprise a second distance sensor, for example arranged between the first and second parts 13 and 15 of the arm 7. The second physical input variable is then a second distance measured between two respective references of the first part 13 of the arm 7 and of the second part 15 of the arm 7.

The machine 1 according to the invention can take recourse, instead of to hydraulic jacks, to electrical actuators combined with electrical switching means replacing the valve or valves or solenoid valves.

The invention is of course not limited to the embodiments and variants of embodiment described and represented in the appended figures. Modifications remain possible, in particular as regards the constitution, the arrangement or the number of the various elements, by different combination of the aforementioned features, or by substitution of technical equivalents, without thereby departing from the scope of protection of the invention.

What is claimed as new and desired to be secured by Letters Patent of the United States is:

1. Agricultural machine for harvesting forage, displaceable in a direction of advance and comprising a chassis to which at least one arm carrying at least one work tool is articulated, this arm comprising at least a first part articulated directly or indirectly to the chassis and a second part connected in a mobile manner to the first part and carrying the work tool, the machine also comprising at least a first actuating device connected to the first part and a second actuating device connected to the second part, at least one of these first and second actuating devices being controlled to adjust a distance measured transversely to the direction of advance and from which the work tool extends laterally relative to the chassis, between a minimum value and a maximum value, at least the other of these first and second actuating devices being controlled to displace the work tool vertically between at least one work position and at least one raised position in which the work tool extends at a certain height above the ground, the machine comprising servo-control means for positioning at least one of these first and second actuating devices in accordance with a control setpoint which determines a target height of the work tool relative to the ground, wherein the servo-control means are configured to raise the work tool to a height above the ground substantially equal to this target height, from at least two transverse work positions of the work tool located at a distance from the chassis between the minimum and maximum values.

2. Machine according to claim 1, wherein the servo-control means are configured to raise the work tool to a height above the ground substantially equal to this target height, from any transverse work position of the work tool located at a distance from the chassis between the minimum and maximum values.

3. Machine according to claim 1, wherein the servo-control means comprise a conversion means which delivers, on the basis of at least one physical input variable representative of a transverse work position of the work tool located at a distance from the chassis between the minimum and maximum values, at least one control variable used for controlling at least one of the first and second actuating devices.

4. Machine according to claim 3, wherein the physical input variable is representative of a position of the second part of the arm relative to the first part of the arm or relative to the chassis, or of a position of the first part of the arm relative to the chassis, or one physical input variable is representative of a position of the second part of the arm relative to the first part of the arm or relative to the chassis, whilst another physical input variable is representative of a position of the first part of the arm relative to the chassis.

5. Machine according to claim 3, wherein the control variable is delivered to a control element controlled for opening and closing and connected to the first or the second actuating device, and the control element allows a power flow towards the first or the second actuating device as long as the value of the control variable has not reached a target value.

6. Machine according to claim 3, wherein each control variable is delivered to a respective control element controlled for opening and closing and connected to the first, respectively the second actuating device, and each control element allows a power flow towards the first, respectively the second actuating device as long as the value of the corresponding control variable has not reached a corresponding target value.

7. Machine according to claim 5, wherein a relationship links the target value(s) to the value(s) taken by the physical input variable(s), to the control setpoint, to dimensional parameters of the arm and/or of the conversion means and to location parameters of the first part of the arm on the chassis.

8. Machine according to claim 6, wherein a relationship links the target value(s) to the value(s) taken by the physical input variable(s), to the control setpoint, to dimensional parameters of the arm and/or of the conversion means and to location parameters of the first part of the arm on the chassis.

9. Machine according to claim 1, wherein the servo-control means comprise an adjustment means making it possible to adjust the control setpoint.

10. Machine according to claim 3, wherein the conversion means comprise a rod and/or cable transmission means articulated to the second part of the arm on one hand and to the first part of the arm or to the chassis on another hand.

11. Machine according to claim 10, wherein the transmission means acts on a mechanical actuator, whereof a position is used as control variable of a (the) control element constituted by a valve connected to the first or the second actuating device.

12. Machine according to claim 9, wherein the adjustment means makes it possible to offset the mechanical actuator in position relative to the arm and/or relative to the control element.

13. Machine according to claim 3, wherein the conversion means comprises a first measuring means supplying a first signal image of a first physical input variable representative of a position of the first part of the arm relative to the chassis, as well as a second measuring means supplying a second signal image of a second physical input variable representative of a position of the second part of the arm relative to the first part of the arm or relative to the chassis.

14. Machine according to claim 13, wherein the conversion means comprises a computer which memorizes the control setpoint, receives the first and second signals in real time and delivers the control variable in real time in order to control at least one of the first and second actuating devices.

15. Machine according to claim 14, wherein the computer stores a law involving the control setpoint, the values taken in real time by the first and second signals, dimensional parameters of the arm as well as location parameters of the first part of the arm on the chassis.

16. The machine according to claim 15, wherein the computer determines, on the basis of the stored law and the control setpoint, a first target value for the first signal and/or a second target value for the second signal.

17. Machine according to claim 16, wherein the computer delivers the control variable in real time to the control element, comprises a first comparator delivering a first comparison signal depending on the divergence between the first target value and the value taken by the first signal, and/or comprises a second comparator delivering a second comparison signal depending on the divergence between the second target value and the value taken by the second signal, and determines the value of the control variable depending on the value taken by the first comparison signal and/or the value taken by the second comparison signal.

18. Machine according to claim 9, wherein the adjustment means comprises a control terminal from which the user can adjust the control setpoint.

19. Machine according to claim 1, wherein the first part of the arm can, by means of the first actuating device, swivel relative to the chassis in a plane transverse to the direction of advance.

20. Machine according to claim 1, wherein the second part of the arm can, by means of the second actuating device, swivel relative to the first part of the arm.

21. Machine according to claim 1, wherein a sliding linkage connects the second part of the arm to the first part of the arm which are displaced the one with respect to the other by means of the second actuating device.

22. Machine according to claim 13, wherein the first measuring means comprises a first angle sensor and that the first physical input variable is a first angle measured between the first part and the chassis.

23. Machine according to claim 13, wherein the second measuring means comprises a second angle sensor and that the second physical input variable is a second angle measured between the second part of the arm and the first part of the arm or between the second part of the arm and the chassis.

24. Machine according to claim 13, wherein the second measuring means comprises a second distance sensor and that the second physical input variable is a second distance measured between two respective references of the first part of the arm and the second part of the arm.
